(19) United States
(12) Patent Application Publication
(10) Pub. No.: US 2013/0046400 A1
(43) Pub. Date: Feb. 21, 2013

(54) Reiterative isolated independent transfer comparison methodology for audio preservation quality control

(71) Applicant: John E. Polito, Burbank, CA (US)

(72) Inventor: John E. Polito, Burbank, CA (US)

(73) Assignee: Mr. John E. Polito, Burbank, CA (US)

(21) Appl. No.: 13/586,974

(22) Filed: Aug. 16, 2012

Related U.S. Application Data
(60) Provisional application No. 61/525,732, filed on Aug. 20, 2011.

(51) Int. Cl. G06F 19/00

(52) U.S. Cl. 700/94

(57) ABSTRACT

The purpose of this invention is to provide an efficient methodology for ensuring that a sound transfer from one medium to another has been performed according to a set of quality standards. Current methods of quality assurance take into account the calibration of the equipment in ideal conditions, but do not take into account the physical condition of the media or errors that may have occurred when the media was originally recorded. This invention quickly and elegantly confirms that a “preservation transfer” meets quality standards by comparing it to a short test “evaluation transfer” that is performed independently of the preservation transfer on a second system isolated from the primary system. The comparison can be made by a human or by computer software. Equipment problems, media problems, or engineer mistakes are quickly discovered and eliminated using this methodology, whereas without this invention, these same issues could go undiscovered.

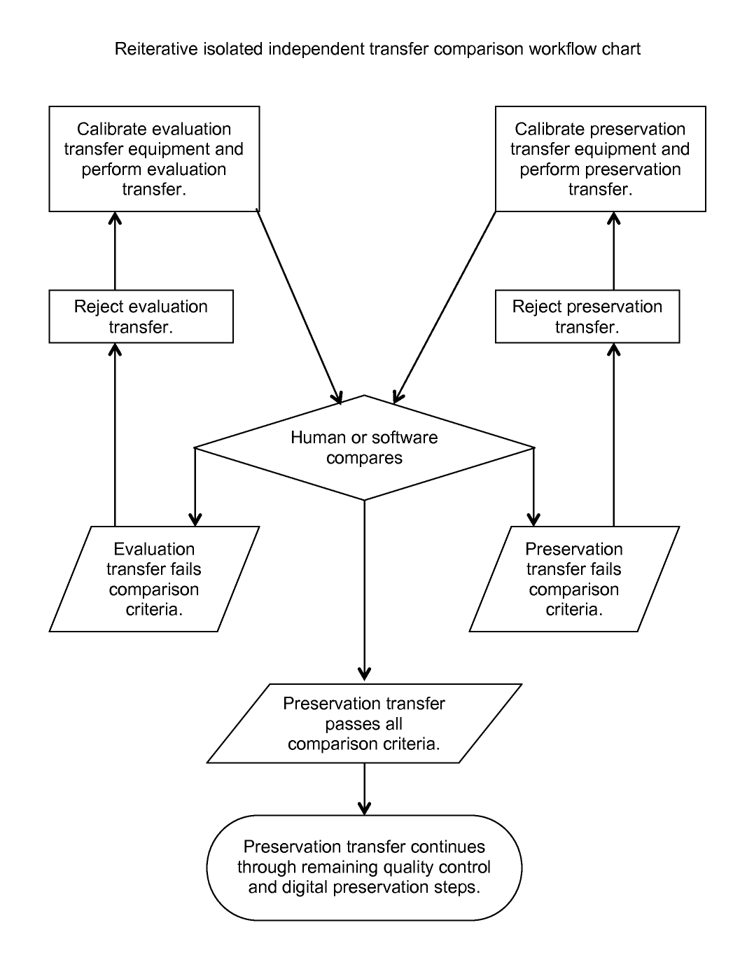

### CROSS-REFERENCE TO RELATED APPLICATIONS

[Not Applicable]

### BRIEF DESCRIPTION OF THE DRAWING

The drawing contains a flowchart of the workflow for the isolated independent transfer comparison methodology for audio preservation quality control.

### BRIEF SUMMARY OF THE INVENTION

The purpose of this invention is to provide an efficient methodology for ensuring that a sound transfer from one medium to another has been performed according to a set of quality standards. The goal of this methodology is to know that one has achieved a high quality audio transfer. The focus of this methodology is ensuring quality control when transferring any analog or digital audio format to a digital audio format.

### BACKGROUND OF THE INVENTION

Before a sound transfer takes place, a sound engineer must make sure that the playback equipment is calibrated properly for the specific media that is being transferred. Ideally there are calibration tones on the media that are played through the machine in order for the engineer to calibrate the playback machine. One tone is used to set the output level of the machine and is traditionally at 1000 Hz. A second tone is used to set the bass equalization of the machine and is traditionally at 100 Hz or lower. A third tone is used to set the treble equalization and is traditionally at 5000 Hz or higher. A fourth tone may be used to set the azimuth of the playback head and is traditionally at 10000 Hz or higher. Other tones or pink noise may be included to calibrate equalization or noise reduction settings on the media such as Dolby A, or Dolby SR. There are also digital audio machines that are much more difficult to calibrate and typically require a knowledgeable service technical.

In addition to calibrating the playback equipment, the engineer must also make sure that the recording equipment is calibrated properly. There are many types of recording equipment, and each has its own set of requirements for ensuring that it is calibrated properly for receiving audio from the playback equipment. The recording equipment can record either analog or digital audio, but in today's world, the recording equipment is typically some type of digital recorder or digital audio workstation.

The transfer engineer must also consider the physical and technical conditions of the media being transferred. The media may be relatively new and have been recorded properly, or it may have been made with some technical or physical flaw that can be compensated by making adjustments to the playback and/or recording equipment, or it may be extremely old and in a state of deterioration, in which case the engineer may have to make further adjustments to the playback and/or recording equipment, or treat the media for its particular state of deterioration before attempting the transfer.

In short, a sound transfer engineer must ensure that the playback and recording equipment are calibrated properly for the specific media being transferred, and the media itself must be properly inspected and conditioned in order to achieve an optimal transfer.

Even if the transfer engineer has done a good job calibrating the transfer equipment and playback media, it may still be difficult to know if the transfer has been done properly mostly because it's often difficult to know the quality of the audio that was recorded to the playback media when it was originally created. Perhaps the production quality was not very good and so the original audio may have hum or hiss in it that might cause a quality control engineer to assume there is something wrong with the transfer when, in fact, the problem is inherent to the original production of the audio. In addition, even the best engineers can make mistakes, and when trying to transfer a large volume of material, human error is almost a guarantee.

One method that has been used to ensure the quality of transfer is to provide the transfer engineer with a pre-recorded “fingerprint” media with known calibration tones and perhaps even a known audio example. After the engineer has calibrated his transfer equipment, he first transfers the known “fingerprint” media followed by the desired playback media. The fingerprint audio sample is then inspected before listening to the audio transfer. Any problems that appear on the known fingerprint audio sample will indicate that there is likely a problem with the calibration of the transfer equipment, and so there is likely a problem with the transfer. This method of using a “fingerprint” media is useful, but there are two major drawbacks to it. First of all, a fingerprint media must be created for every audio format being transferred, and for each and every transfer facility performing the transfers. In a large-scale transfer environment, this can quickly become a daunting task when considering that there are many different audio media formats and there may be many transfer facilities involved in the effort. The second problem is that the fingerprint may tell you with precise accuracy how well the transfer equipment is calibrated and running, but it tells you nothing about how well the particular media being transferred is behaving on the equipment. The media may be in a deteriorating state, and it may be that calibration required to playback the deteriorated media optimally is quite different from the calibration required to playback the fingerprint media. This is not an uncommon problem in a large library containing media in varying states of deterioration.

Another method that has been used for audio quality control in a large-scale preservation effort is software that will analyze the transfer audio and look for analog anomalies that are known to be undesirable; issues like clicks, dropouts, hum, and frequency response are analyzed and a report is automatically generated for the quality control engineer to evaluate. The problem with this method is that it does not tell you if the machine was calibrated properly, or if the playback media responded well during the transfer. The engineer has no way of knowing if the reported anomalies were inherent to the recording, or introduced during the transfer process.

Another method that is used for audio quality control is to simply have the quality control engineer listen through the transferred audio and search for problems that might indicate a faulty transfer. While a highly experienced transfer engineer may be able to get good results to some degree using this method, there is no way to determine if the transfer equipment was calibrated optimally, or if the playback media responded well during the transfer. For example, the frequency balance of the transfer may be less than ideal, and the quality control engineer may assume that “that's just how the recording sounds”.

### DETAILED DESCRIPTION OF THE INVENTION

Reiterative isolated independent transfer comparison methodology:

The reiterative isolated independent transfer comparison methodology is used to quickly and efficiently determine the quality of an audio transfer. The key is to perform independent transfers on two separate, properly calibrated transfer setups, preferably by two separate engineers. The first transfer will be referred to as the “evaluation transfer” and is a short sample of the playback media sufficient to determine the overall quality of the audio on the playback media. It can be a complete transfer, and in some cases this may be desirable, but the goal here is efficiency. The second transfer will be referred to as the “preservation transfer”. The preservation transfer is a complete transfer of the playback media that is intended to be the final transfer for long-term preservation once it passes the quality control stage.

Once both transfers are complete, the preservation transfer is compared to the evaluation transfer. The comparison can be made by automated software, by a qualified quality control engineer, or by both. The easiest way for an engineer to do the comparison is to line up both transfers in a digital audio workstation so that they can be played simultaneously in sync, or quickly selected individually while they are both playing. The entire comparison process will typically take less than 5 minutes. Software comparisons can be even faster and fully automated.

By comparing two transfers made on independent systems, it is easy to quickly verify proper machine calibration, speed/drift, frequency response, system noise, level, wow and flutter, head contact, azimuth, and general transfer stability. If there is a discrepancy between the two transfers, it is generally easy to determine whether the evaluation transfer is incorrect or the preservation transfer. If the preservation transfer is at fault, then it is performed again and compared to the evaluation transfer until it is correct. If the evaluation transfer is at fault, then a determination is made as to why the fault occurred and actions are taken to correct it. A new evaluation transfer can be made to confirm that the corrections were effective.

To put this into context of a large-scale audio preservation effort, the evaluation transfers are desirable to make beyond the scope of quality control when determining the best copy of a particular recording to preserve. Here is a typical scenario utilizing the reiterative isolated independent transfer comparison methodology: There are four copies of a 90-minute recording that needs to be preserved. An audio engineer performs a short evaluation transfer of the first 5-10 minutes of the recording from each of the four copies. The engineer determines which copy is the best and then sends that copy to an independent transfer facility to perform a preservation copy. The transfer comes back and the quality control engineer compares it to the evaluation transfer of the same media. The engineer notes that the preservation transfer has 60 Hz hum not present in the evaluation transfer. The preservation transfer is rejected and sent back to the transfer facility noting the problem. The transfer facility investigates and determines the source of the 60 Hz hum. A new transfer is made and returned to the quality control engineer. A new comparison is made and now the second transfer does not have the 60 Hz hum, but is playing back slightly faster than before. The preservation transfer is rejected again and sent back to the transfer facility noting the problem. The transfer facility determines the source of the problem and a new transfer is made. The new transfer is returned to the quality control engineer who compares it to the evaluation transfer and determines that there are no technical problems. The preservation transfer then receives a complete listen through by the quality control engineer who has a clear image in his mind of what the rest of the transfer should sound like. Since it is common to have hum inherent to an audio recording, the quality control engineer may not have known there was a transfer problem without the evaluation transfer. The same is true for the speed issue; without the evaluation transfer to compare it to, the engineer may not have been able to determine this problem.

Both of the problems in this scenario would have also been detected by the fingerprint methodology explained above, but there are audio issues that cannot be determined by the fingerprint methodology. Those issues are generally specific to the deterioration level of the playback media, or a technical problem with the original recording of the playback media. Examples are: head contact, wow, flutter, head buildup, azimuth, sync tone playback calibration setup, and overall fidelity. All of these issues can severely degrade the quality of the playback transfer and are undetectable by using the fingerprint methodology, because the fingerprint methodology only tells you how well the transfer equipment is calibrated; it does not tell you anything about how the playback media itself is responding to the transfer equipment.

Executing efficient quality control is highly desirable in a large-scale audio preservation effort. Evaluation transfers are useful to determine which copies to preserve, and then are utilized during the quality control phase to quickly and efficiently determine if the preservation transfer equipment was calibrated properly and if the playback media responded well during the transfer. The reiterative isolated independent transfer comparison methodology can detect equipment failures and continually improves the quality of transfer for both evaluation transfers and preservation transfers. Remember, if the preservation transfer is noticeably better than the evaluation transfer, then the evaluation transfer equipment must be improved. If the evaluation transfer is noticeably better than the preservation transfer, then the preservation transfer equipment must be improved. The end result is that the process is constantly improving itself by providing feedback to the entire transfer chain.

The invention claimed is:

1. A methodology that provides an efficient and thorough means of assuring the quality of an audio transfer comprising: a secondary isolated transfer setup to perform a short “evaluation transfer” that is compared to the full-length “preservation transfer” needing quality assurance.

2. The method of claim 1, further comprising of a reiterative workflow whereby the comparison, performed by a human and/or a computer, causes the “evaluation transfer” and/or the “preservation transfer” to be rejected, thus forcing a re-calibration and/or repairs of the rejected transfer setup and a new transfer for comparison.

3. The method of claim 2, whereby rejected transfer setups are re-calibrated and repaired, and rejected transfers are re-transferred and compared reiteratively until the transfer passes all defined quality assurance comparisons.
